(19) United States
(12) Patent Application Publication
(10) Pub. No.: US 2017/0192102 A1
(43) Pub. Date: Jul. 6, 2017

(54) eLORAN POSITIONING VIA CROWDSOURCING

(71) Applicant: QUALCOMM Incorporated, San Diego, CA (US)

(72) Inventor: Richard Dominic Wietfeldt, San Diego, CA (US)

(21) Appl. No.: 14/987,638

(22) Filed: Jan. 4, 2016

(51) Int. Cl. G01S 19/46; H04W 4/02

(52) U.S. Cl. CPC G01S 19/46; H04W 4/02

(57) ABSTRACT

Example methods, apparatuses, and/or articles of manufacture are disclosed herein that may be utilized, in whole or in part, to facilitate and/or support one or more operations and/or techniques for improved Enhanced Long-Range Navigation (eLORAN) positioning via crowdsourcing, such as for use in or with mobile communication devices, for example.

### BACKGROUND

1. Field

The present disclosure relates generally to position or location estimations of mobile communication devices and, more particularly, to improved Enhanced Long-Range Navigation (eLORAN) positioning via crowdsourcing for use in or with mobile communication devices.

2. Information

Mobile communication devices, such as, for example, cellular telephones, portable navigation units, laptop computers, personal digital assistants, on-board navigation systems, or the like are becoming more common every day. Certain mobile communication devices, such as, for example, location-aware cellular telephones, smart telephones, on-board navigation systems, or the like may assist users in estimating their geographic locations by providing positioning assistance parameters obtained or gathered from various systems. For example, in an outdoor environment, certain mobile communication devices may obtain an estimate of their geographic location or so-called “position fix” by acquiring wireless signals from a satellite positioning system (SPS), such as the global positioning system (GPS) or other like Global Navigation Satellite Systems (GNSS), cellular base station, etc. via a cellular telephone or other wireless or electronic communications network. Acquired wireless signals may, for example, be processed by or at a mobile communication device, and its location may be estimated using known techniques, such as Advanced Forward Link Trilateration (AFLT), base station identification, cell tower triangulation, or the like.

In certain outdoor or indoor-like environments, however, such as in urban and/or deep natural canyons, in-between buildings and/or in foliage, for example, mobile communication devices may be unable to reliably receive or acquire satellite or like wireless signals to facilitate and/or support one or more position estimation techniques. For example, signals from an SPS or other wireless transmitters may be attenuated or otherwise affected in some manner (e.g., insufficient, weak, fragmentary, etc.), which may at least partially preclude their use for position estimations. Thus, at times, in a certain outdoor or indoor-like environment, such as partially enclosed areas, for example, different techniques may be employed to enable navigation or location services. For example, a mobile device may obtain a position fix by at least partially utilizing a positioning service that may be provided by a land-based navigation system, such as eLORAN. At times, however, a land-based navigation system, such as eLORAN, for example, may be less precise, which may be due, at least in part, to changes in ground conductivity, temperature, pressure, and/or moisture content of the atmosphere, or the like.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a flow diagram illustrating an implementation of an example process that may be performed to facilitate and/or support improved eLORAN positioning via crowdsourcing.

FIG. 3 is a schematic flow diagram of an implementation of a process illustrating an example use case of improved eLORAN positioning via crowdsourcing.

FIG. 4 is a schematic diagram illustrating an implementation of an example computing environment associated with a mobile device.

FIG. 5 is a schematic diagram illustrating an implementation of an example computing environment associated with a server.

### SUMMARY

Example implementations relate to techniques for improved Enhanced Long-Range Navigation (eLORAN) positioning via crowdsourcing for use in or with mobile communication devices. In one implementation, a method may comprise acquiring, at a mobile device, one or more Enhanced Long-Range Navigation (eLORAN) positioning signals to obtain one or more Additional Secondary Factor (ASF) measurements; obtaining, via a Global Navigation Satellite System (GNSS), an estimated location of the mobile device relative to time of day (e.g., Coordinated Universal Time (UTC), Global Positioning System (GPS) time, etc.); and transmitting one or more messages comprising the one or more ASF measurements and the estimated location relative to the time of day to a server.

In another implementation, an apparatus may comprise a communication interface to communicate with an electronic communications network, the communication interface configured to acquire one or more eLORAN positioning signals to obtain one or more ASF measurements; and obtain, via a GNSS, an estimated location of the mobile device relative to time of day (e.g., Coordinated Universal Time (UTC), Global Positioning System (GPS) time, etc.); and one or more processors coupled to a memory and to the communication interface, the one or more processors configured to transmit one or more messages comprising the one or more ASF measurements and the estimated location relative to the time of day to a server.

In yet another implementation, a method may comprise receiving, at a server, first messages from a plurality of reporting mobile devices comprising one or more ASF measurements based, at least in part, on eLORAN positioning signals acquired at the reporting mobile devices, and estimates of locations of the reporting mobile devices relative to time of day contemporaneous with the acquisitions of the eLORAN positioning signals; computing one or more updated ASF parameters based, at least in part, on the estimates of locations of the reporting mobile devices relative to the time of day and the one or more ASF measurements; and transmitting one or more second messages comprising one or more updated ASF parameters to one or more client mobile devices or eLORAN receiving stations or eLORAN transmitting stations.

In yet another implementation, an apparatus may comprise a communication interface to transmit messages to and receive messages from a plurality of communication devices, the communication interface configured to receive first messages from a plurality of reporting mobile devices comprising one or more ASF measurements based, at least in part, on eLORAN positioning signals acquired at the reporting mobile devices, and estimates of locations of the reporting mobile devices relative to time of day contemporaneous with the acquisitions of the eLORAN positioning signals; and one or more processors coupled to a memory and to the communication interface, the one or more processors configured to compute one or more updated ASF parameters based, at least in part, on the estimates of locations of the reporting mobile devices relative to the time of day and the one or more ASF measurements; the communication interface further configured to transmit one or more second messages comprising one or more updated ASF parameters to one or more client mobile devices or eLORAN receiving stations or eLORAN transmitting stations. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be implemented, in whole or in part, to facilitate and/or support one or more operations and/or techniques for improved eLORAN positioning via crowdsourcing for use in or with mobile communication devices. As used herein, “mobile device,” “mobile communication device,” “location-aware mobile device,” or like terms may be used interchangeably and refer to any kind of special purpose computing platform or apparatus that may from time to time have a position or location that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be called simply mobile devices, may include, for example, cellular telephones, smart telephones, personal digital assistants (PDAs), laptop computers, personal entertainment systems, tablet personal computers (PC), personal audio or video devices, personal navigation devices, radio heat map or other map generation tools, on-board navigation systems, or the like.

It should be appreciated, however, that these are merely examples of mobile devices that may be used, at least in part, to implement one or more operations and/or techniques for improved eLORAN positioning via crowdsourcing, and that claimed subject matter is not limited in this regard. For example, in some instances, one or more operations and/or techniques for improved eLORAN positioning may be utilized, at least in part, in connection with a cable-modem-type voice-over-IP (VOIP) or like telephone, which may not be coupled to a Plain Old Telephone System (POTS), meaning that, at times, a location of such a telephone may not be reliably or otherwise sufficiently estimated, such as via a POTS location assignments (e.g. upon installation, etc.) and/or network. Thus, one or more operations and/or techniques for improved eLORAN positioning discussed herein, such as employed in connection with an eLORAN and/or cellular receiver, for example, may be implemented to facilitate and/or support improved and/or more consistent location determination with respect to these or like telephones. It should also be noted that the terms “position” and “location” may be used interchangeably herein.

In this context, “crowdsourcing” refers to a process of measuring, collecting, generating, communicating, etc. applicable data by one or more agents, clients, and/or users, such as via mobile devices, for example, while traveling within an area of interest. The terms “agent,” “client,” “crowdsourcing user,” or simply “user” may be used interchangeably herein and refer to a person, device, and/or application that may facilitate and/or support one or more crowdsourcing operations and/or techniques.

Thus, at times, users of mobile devices may execute desired tasks (e.g., collect observations of wireless transceivers, communicate position fixes, etc.) and be rewarded in some manner for doing so. For example, as will be seen, in some instances, users may crowdsource one or more Additional Secondary Factor (ASF) measurements, among others, that may be used, at least in part, in updating one or more ASF correction parameters for use, at least in part, in eLORAN positioning. Rewards may, for example, be in the form of a discount for a wireless service, mobile device, merchandize, etc., manufacturer and/or store coupons, mobile device and/or service upgrades, or the like. At times, crowdsourced data may, for example, be collected, stored, communicated, etc. via a suitable host crowdsourcing application, which may be provided to a user's mobile device by a suitable server, stored locally on a mobile device, etc. A crowdsourcing application may, for example, be activated, launched, downloaded, etc. upon user's entering an area of interest, upon request, user input, or the like. Crowdsourced data may, for example, be communicated to another device, such as a suitable server, peer device, etc. using any suitable approach, such via a “push” technology, just to illustrate one possible implementation. Claimed subject matter is not so limited, of course. For example, at times, crowdsourced data may be extracted (e.g., by a server, location-based service (LBS), peer device, etc.) from a memory of like repository (e.g., a temporary buffer, etc.) of a crowdsourcing mobile device via a “pull” technology upon appropriate authorization. Crowdsourcing and/or related applications are generally known and need not be described here in greater detail.

As was indicated, a position fix of a mobile device may be obtained based, at least in part, on information gathered from various systems. One such system may comprise, for example, a satellite positioning system, such as a GNSS. At times, however, a satellite positioning system may be vulnerable to disruptions, such as if a satellite signal is lost, fragmentary, insufficient, etc. due, at least in part, to interferences from a variety of sources and/or conditions (e.g., space weather events, intentional signal blockage, etc.). Thus, in some instances, such as if a GNSS signal is not reliably available, it may be desirable or otherwise useful to employ a terrestrial or land-based navigation system, such as a back up or complimentary system, for example. As such, as alluded to previously, at times, eLORAN may, for example, be employed, such as instead of or in addition to a GNSS.

eLORAN is a low frequency terrestrial or land-based navigation system comprising a chain of transmitting stations (eLORAN transmitters) emitting precisely timed and shaped radio frequency pulses centered at about 100 kHz (LORAN pulses) that follow the Earth's surface and are typically synchronized to Coordinated Universal Time (UTC). Emitted LORAN pulses are then received by a number of eLORAN receivers that measure times of arrival (TOAs) from and/or ranges to all eLORAN transmitters in view. eLORAN receivers also decode and/or demodulate LORAN data channel (LDC) messages, such as to identify timing of an individual eLORAN pulse from a particular eLORAN transmitter, correct for variations caused by propagation delays, or the like. eLORAN receivers, thus, may estimate their position using TOA measurements and propagation velocity of LORAN pulses by interpolating between tabulated hyperbolic lines of position to determine an intersection with a current line of position corresponding to a time difference measured from three or more eLORAN transmitters, with appropriate corrections. Again, eLORAN is generally known and need not be described here in greater detail.

As was indicated, eLORAN pulses typically propagate by following the surface of the Earth (e.g., via a ground wave) and, as such, may accumulate a number of delays relative to the speed of light due, at least in part, to various encountered topographic features and/or their respective conductivity. Thus, to more accurately estimate TOAs from an eLORAN transmitter to receiver and obtain a more accurate position fix, accounting or correcting for such delays may be needed or otherwise useful. In some instances, this may, for example, be accomplished, at least in part, via TOA corrections that may help to compensate for delays caused by the above-referenced propagation phenomena. To accomplish this, three phase factors may, for example, be utilized, in whole or in part, or otherwise considered.

Primary Factor (PF) is due, at least in part, to a signal travelling slower in air than in free-space, as parameterized by index of refraction of atmospheric air (e.g., vacuum-to-air path conversion). For this factor, deviations may be relatively minor (e.g., less than 10.0 meters in position), and applicable PF parameters may be relatively accurately or sufficiently modeled.

Secondary Factor (SF) is due, at least in part, to the presence of the Earth's surface and electrical properties of the oceans (e.g., air-to-all seawater path conversion). Likewise, it is possible to relatively accurately or sufficiently model SF contribution from seawater using one or more suitable approaches (e.g., Brunays' equations, etc.).

Additional Secondary Factor (ASF) is due, at least in part, to additional electrical resistance encountered by land terrain (e.g., water-to-land path conversion), meaning that any land encountered with a surface conductivity lower than seawater will delay a LORAN pulse even further. In certain simulations or experiments, it has been observed that ASF may have larger variations (spatial and/or temporal) and, thus, may constitute a principal factor limiting position accuracy of eLORAN. As indicated above, while PF and SF may be relatively accurately or sufficiently modeled (e.g., via the Loran Path Model (LPM), etc.), such as without use of additional measurements, for example, ASF may be more difficult or, at times, impossible to model due, at least in part, to rapid decorrelation of fixed AFS values. As such, without timely and/or accurate measurement-based calibration, ASF may, for example, introduce major inaccuracies to eLORAN positioning.

Typically, although not necessarily, ASF values are comprehensively measured for a particular geographic area at a given time and subsequently uploaded to and/or stored at applicable eLORAN receivers, such as in the form of tables of ASF values, for example, which may be differential correctable. Since ASF depends on ground conductivity along a propagation path of a LORAN pulse, as mentioned above, changes in ground conductivity may result in changes in ASF. For example, seasonal effects, such as amount of rain water soaking into the soil, formation of ice, etc. may change electrical conductivity of a particular land portion, which in turn may change corresponding ASF values. In addition, changes in temperature, pressure, and/or moisture content of the atmosphere over time may, for example, alter PF speed of light. Although this is technically may not be considered a change in ASF, it may nonetheless appear so to an eLORAN user, for example, since PF variations are often lumped together with ASF variations. Thus, because ASF is time and/or position variable, quality of previously measured ASF values stored at an eLORAN receiver may decrease over time. Accordingly, it may be desirable to develop one or more methods, systems, and/or apparatuses that may implement more efficient and/or more effective eLORAN positioning, such as via crowdsourcing ASF measurements, among other things, using mobile devices, for example, which may help to eliminate or reduce ASF reporting errors from fixed transmitters and/or fixed or mobile receivers, obtain finer real-time or near real-time distributions of ASF values (e.g., a real-time ASF grid or map, etc.), serve as a satellite positioning system backup or complement, or the like. In this context, “real time” refers to an amount of timeliness of eLORAN measurements and/or values (e.g., ASF, etc.), which may have been delayed by, for example, an amount of time attributable to electronic communication and/or signal processing. For example, in some instances, real time eLORAN measurements and/or values may comprise measurements and/or values measured in seconds or minutes. As such, in this context, longer measurement intervals, such as measured in hours, days, or weeks, for example, may be considered “non-real time.”

Thus, as will be discussed in greater detail below, in an implementation, a crowdsourcing mobile device may obtain one or more ASF values at a location of interest using one or more TOA measurements of eLORAN pulses, for example, while contemporaneously leveraging a satellite positioning system-derived position fix in relation to time of day. In an implementation, a satellite positioning system may comprise, for example, a GNSS, and time of day may comprise, for example, GPS time or UTC. Crowdsourced data may be transmitted to a suitable device, such as a server and/or peer device, for example, via one or more messages that may comprise one or more ASF measurements, estimated locations in relation to time of day, etc. Based, at least in part, on crowdsourced data, a real-time or near real-time ASF map or grid may, for example, be generated (e.g., with new ASF values, etc.) and/or updated (e.g., with ASF corrections, etc.) and may be transmitted to one or more participating mobile devices and/or eLORAN transmitters via a cellular communication channel and/or LDC for more accurate eLORAN positioning, as will also be seen.

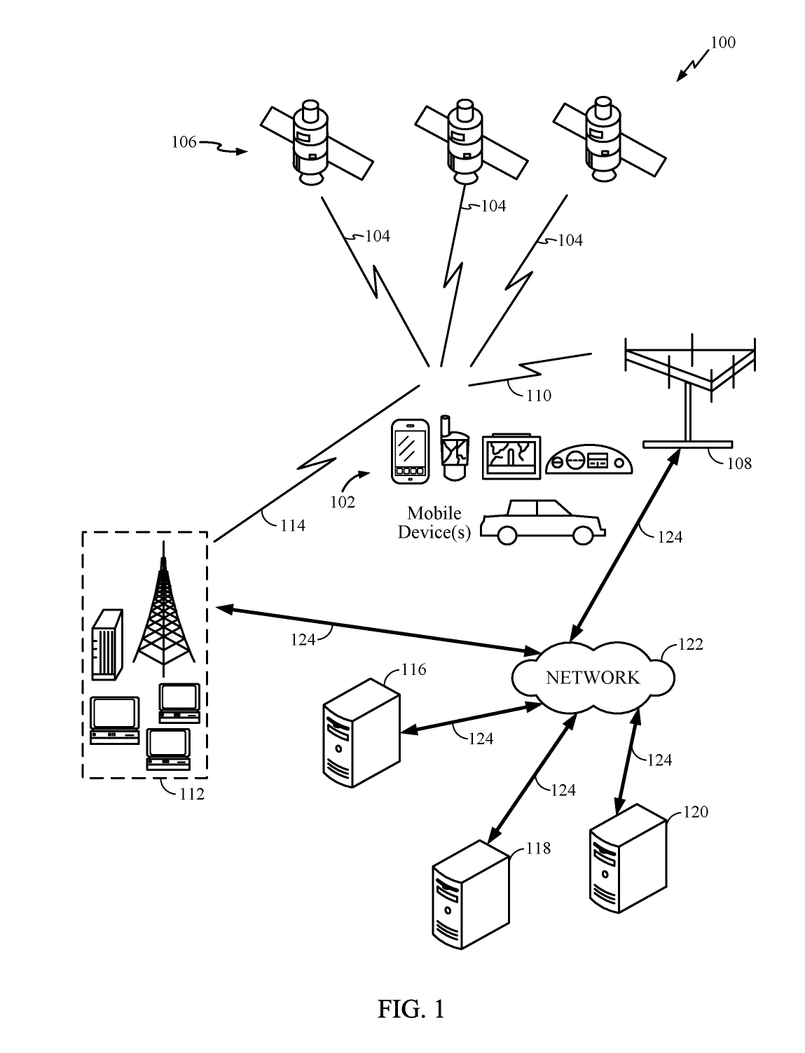

FIG. 1 is a schematic diagram illustrating features associated with an implementation of an example operating environment 100 capable of facilitating or supporting one or more processes or operations for improved eLORAN positioning via crowdsourcing for use in or with mobile devices, such as, for example, one or more mobile devices 102 (e.g., hand-held units, on-board systems, vehicle dashboards, etc.). It should be appreciated that operating environment 100 is described herein as a non-limiting example that may be implemented, in whole or in part, in the context of various electronic communications networks or combination of such networks, such as public networks (e.g., the Internet, the World Wide Web), private networks (e.g., intranets), WWAN, wireless local area networks (WLAN, etc.), cellular networks, or the like. It should also be noted that claimed subject matter is not limited to outdoor implementations. For example, at times, one or more operations or techniques described herein may be performed, at least in part, in an indoor-like environment, which may include partially or substantially enclosed areas, such as urban or natural canyons, town squares, amphitheaters, or the like. At times, one or more operations or techniques described herein may be performed, at least in part, in an indoor environment.

As illustrated, in an implementation, one or more mobile devices 102 may, for example, receive or acquire satellite positioning system (SPS) signals 104 from SPS satellites 106. In some instances, SPS satellites 106 may be from a single global navigation satellite system (GNSS), such as the GPS or Galileo satellite systems, for example. In other instances, SPS satellites 106 may be from multiple GNSS such as, but not limited to, GPS, Galileo, Glonass, or Beidou (Compass) satellite systems. In certain implementations, SPS satellites 106 may be from any one several regional navigation satellite systems (RNSS) such as, for example, WAAS, EGNOS, QZSS, just to name a few examples.

At times, one or more mobile devices 102 may, for example, transmit wireless signals to, or receive wireless signals from, a suitable wireless communication network. In one example, one or more mobile devices 102 may communicate with a cellular communication network, such as by transmitting wireless signals to, or receiving wireless signals from, a base station transceiver 108 over a wireless communication link 110, for example. Similarly, one or more mobile devices 102 may transmit wireless signals to, or receive wireless signals from a transmitter and/or receiver associated with an eLORAN navigation system, indicated generally via a dashed line at 112. For example, as was indicated, an eLORAN transmitter may transmit one or more LORAN pulses (not shown) with one or more LDC messages that may be acquired by one or more mobile devices 102 so as to obtain one or more corresponding ASF measurements utilizing TOAs of such pulses. In some instances, one or more mobile devices 102 may, for example, be capable of communicating with eLORAN 112, such as in connection with a differential eLORAN reference station (not shown) and/or via base station transceiver 108 over a network 122 via links 110 and/or 124, for example, or, optionally or alternatively, directly via a wireless communication link 114. Base station transceiver 108 may comprise, for example, an access point, radio beacon, cellular base station, reference station, femtocell, or the like, depending on an implementation. As also discussed below, contemporaneously with acquisition of one or more LORAN pulses, one or more mobile devices 102 may, for example, also obtain position fixes corresponding to their location using signals 104 from SPS satellites 106 in relation to applicable satellite positioning system time (e.g., GPS time, UTC, etc.).

In a particular implementation, base station transceiver 108 may be capable of communicating with one or more mobile devices 102 at a shorter range over wireless communication link 110 than at a range typically established via cellular communications. For example, base station transceiver 108 may be positioned in an indoor or like environment and may provide access to a wireless local area network (WLAN, e.g., IEEE Std. 802.11 network, etc.) or wireless personal area network (WPAN, e.g., Bluetooth® network, etc.). In another example implementation, base station transceiver 108 may comprise a femtocell or picocell capable of facilitating communication via link 110 according to an applicable cellular or like wireless communication protocol. Of course, it should be understood that these are merely examples of networks that may communicate with one or more mobile devices 102 over one or more wireless communication links, and claimed subject matter is not limited in this respect. It should be noted that, in some instances, operating environment 100 may include a larger number of mobile devices 102, base station transceivers 108, networks 122, SPS satellites 106, eLORAN systems 112, etc.

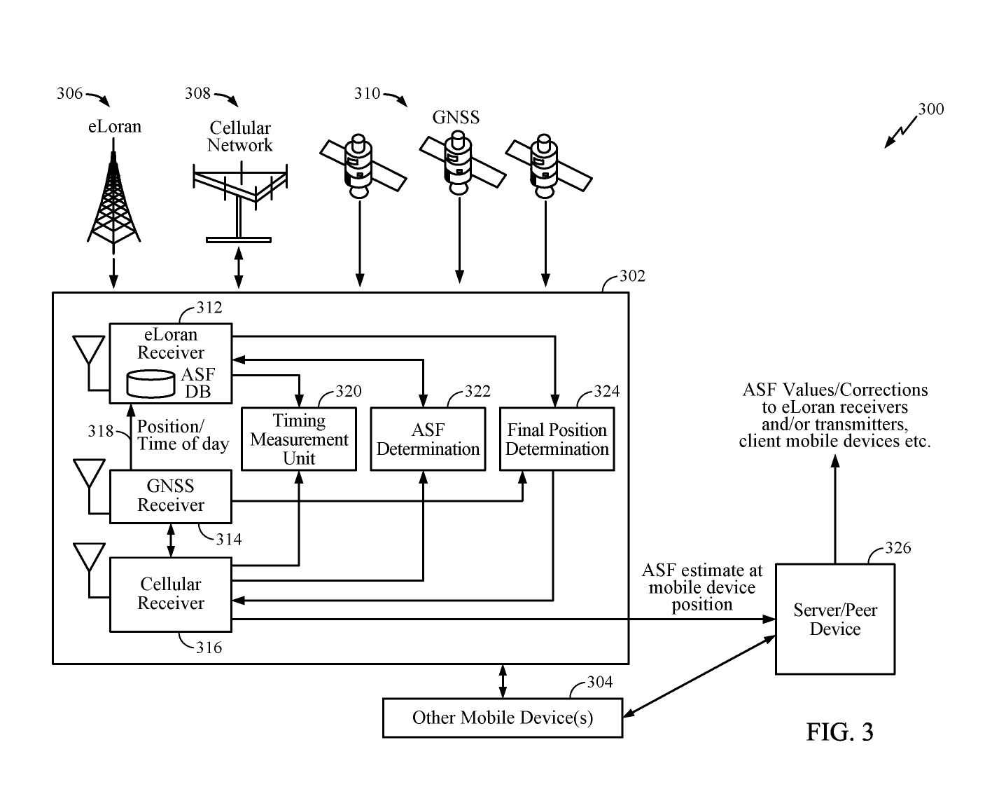

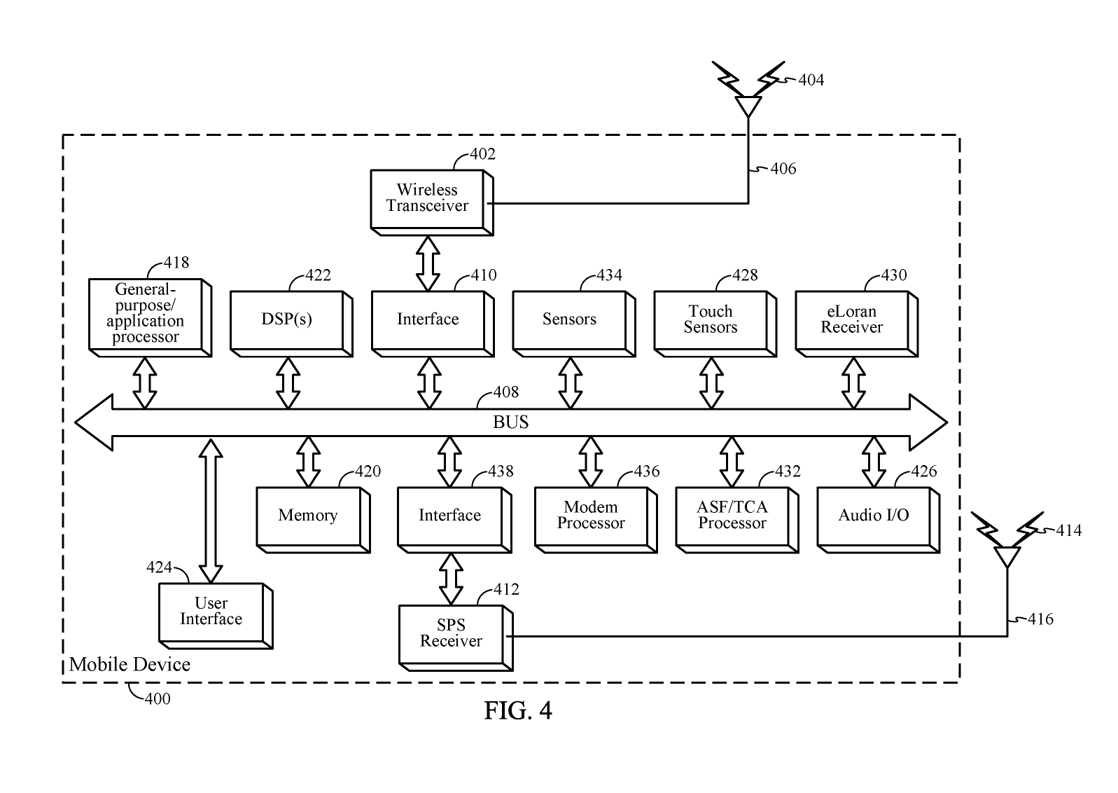

In an implementation, one or more mobile devices 102, base station transceiver 108, eLORAN 112, etc. may communicate with one or more servers 116, 118, or 120 over network 122 via one or more links 110 and/or 124. Network 122 may comprise, for example, any combination of wired and/or wireless communication links and/or networks. In a particular implementation, network 122 may comprise, for example, Internet Protocol (IP)-type infrastructure capable of facilitating or supporting communication between one or more mobile devices 102 and one or more servers 116, 118, 120, etc. via base station transceiver 108, etc. In another implementation, network 122 may comprise, for example, cellular communication network infrastructure, such as a base station controller or master switching center to facilitate and/or support mobile cellular communication with one or more mobile devices 102. As was indicated, in some instances, network 122 may facilitate and/or support communications of one or more mobile devices 102 with eLORAN 112, such as for purposes of providing new or updated ASF values/corrections to eLORAN transmitters, for example. Thus, one or more mobile devices 112 may comprise, for example, an eLORAN receiver, a GNSS receiver, and a cellular receiver, among other things. Particular examples of a mobile device capable of facilitating and/or supporting one or more operations and/or techniques for improved eLORAN positioning via crowdsourcing will be discussed in greater detail below with reference to FIGS. 3 and 4. It should be noted that, depending on an implementation, one or more mobile devices 112 may comprise crowdsourcing mobile devices, such as for purposes of obtaining ASF measurements, for example, and/or client mobile devices, such as implementing one or more positioning operations based, at least in part, on new and/or updated ASF values/corrections.

Servers 116, 118, and/or 120 may comprise any suitable servers or combination thereof capable of facilitating and/or supporting one or more operations or techniques discussed herein. For example, servers 116, 118, and/or 120 may comprise one or more positioning assistance servers, navigation servers, map servers, crowdsourcing servers, network-related servers, or the like. As discussed below, servers 116, 118, and/or 120 may, for example, process crowdsourced ASF measurements to generate or update an ASF map or grid, may combine ASF measurements and SPS location estimates (e.g., GNSS position fixes, etc.) received in messages from one or more mobile devices 102 to compute updated ASF values, may transmit new ASF values or ASF corrections to one or more mobile devices 102 and/or applicable eLORAN transmitters as part of positioning assistance data, or the like. At times, servers 116, 118, or 120 may include, for example, a base station almanac (BSA) or like data indicating locations, identities, orientations, etc. of base station transceiver 108, transmitter(s) of eLORAN 112, etc. in one or more particular areas associated with operating environment 100.

In particular implementations, and as also discussed below, one or more mobile devices 102 may have circuitry or processing resources capable of determining a position fix or estimated location of such devices. For example, if satellite signals 104 are available, one or more mobile devices 102 may compute a position fix based, at least in part, on pseudorange measurements to four or more SPS satellites 106. Here, one or more mobile devices 102 may compute such pseudorange measurements based, at least in part, on pseudonoise code phase detections in signals 104 acquired from four or more SPS satellites 106. In particular implementations, one or more mobile devices 102 may receive from one or more servers 116, 118, or 120 positioning assistance data to aid in the acquisition of signals 104 transmitted by SPS satellites 106 including, for example, almanac, ephemeris data, Doppler search windows, just to name a few examples.

In some implementations, one or more mobile devices 102 may obtain a position fix by processing wireless signals received from one or more terrestrial transmitters positioned at fixed locations (e.g., base station transceiver 108, transmitter of eLORAN 112, etc.) using any one of several techniques, such as, for example, observed time difference of arrival (OTDOA), AFLT, trilateration, triangulation, hyperbolic radio navigation, or the like. These or like techniques are generally known and need not be described here in greater detail. Optionally or alternatively, one or more mobile devices 102 may be capable of obtaining a position fix based, at least in part, on signals acquired from one or more local transmitters (not shown), such as femtocells, WLAN access points, or the like. For example, one or more mobile devices 102 may obtain a position fix by measuring ranges to three or more local transceivers positioned at known locations. In some implementations, one or more mobile devices 102 may, for example, measure ranges by obtaining a Media Access Control (MAC) identifier address from one or more local transceivers and measuring one or more characteristics of received signals, such as signal strength, round trip delay, or the like.

In an implementation, positioning assistance data received from one or more servers 116, 118, and/or 120 by one or more mobile devices 102 may include, for example, radio heat maps, context parameter maps, routeability graphs, etc., just to name a few examples. Other assistance data may include, for example, electronic digital maps of geographic areas of interest for display or to aid in navigation. A geographic map may be provided to one or more mobile devices 102 as it enters a particular geographic area, for example, and may show applicable features, such as topography and/or terrain features, points of interest, such as buildings, routes, cellular of like stations, etc. By obtaining a digital map of a geographic area of interest, one or more mobile devices 102 may, for example, be capable of overlaying their current location over the displayed map of the area so as to provide an associated user with additional context, frame of reference, or the like.

Again, even though a certain number of computing devices, networks, navigation systems, servers, stations, links, etc. are illustrated herein, any number of suitable computing devices, networks, navigation systems, servers, stations, links, etc. may be implemented to facilitate and/or support one or more techniques or processes associated with operating environment 100. For example, at times, network 122 may be coupled to one or more wired and/or wireless communication networks (e.g., WLAN, etc.) so as to enhance a coverage area for communications with one or more mobile devices 102, base station transceiver 108, eLORAN 112, servers 116, 118, 120, or the like. In some instances, network 122 may facilitate and/or support femtocell-based operative regions of coverage, for example. Again, these are merely example implementations, and claimed subject matter is not limited in this regard.

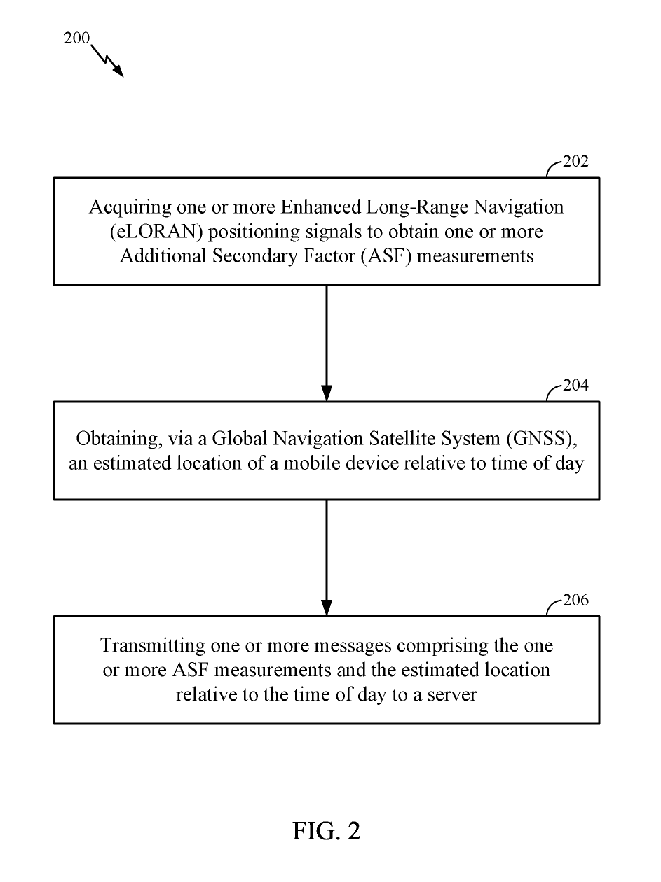

With this in mind, attention is now drawn to FIG. 2, which is a flow diagram illustrating an implementation of an example process 200 that may be performed, in whole or in part, to facilitate and/or support one or more operations or techniques for improved eLORAN positioning via crowdsourcing for use in or with mobile devices, such as one or more mobile devices 102 of FIG. 1, for example. It should be noted that information acquired or produced, such as, for example, input signals, output signals, wireless signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

Example process 200 may, for example, begin at operation 202 with acquiring one or more Enhanced Long-Range Navigation (eLORAN) positioning signals to obtain one or more Additional Secondary Factor (ASF) measurements. As was indicated, eLORAN positioning signals may comprise, for example, one or more LORAN pulses transmitted by a number of eLORAN transmitters and acquired by a number of crowdsourcing mobile devices (e.g., mobile devices 102 of FIG. 1). At times, LORAN pulses may, for example, be synchronized to a suitable reference time of day, such as UTC, just to illustrate one possible implementation. Crowdsourcing mobile devices may, for example, measure TOAs from received eLORAN positioning signals so as to obtain one or more ASF measurements. For example, in some instances, ASF measurements may be obtained by utilizing an expected time of flight (TOF) of an acquired eLORAN positioning signal, such as PF and SF-corrected, for example, as discussed above, and an observed TOF of such a signal. Since a time of emission (TOE) of an eLORAN positioning signal is typically precisely maintained by an eLORAN transmitter relative to time of day (e.g., UTC, etc.), for this example, a measured TOA relative to time of day (e.g., UTC, etc.) may be used, at least in part, to compute an observed TOF, and a corresponding ASF may then comprise the difference between measured and expected TOFs.

With regard to operation 204, an estimated location of the crowdsourcing mobile device may, for example, be obtained relative to time of day, such as via a GNSS, for example. In at least one implementation, such a location estimate may, for example, be obtained contemporaneously with the acquisition of the one or more eLORAN positioning signals. For example, a crowdsourcing mobile device may estimate its location relative to time of day based, at least in part, on a position fix obtained using a GNSS receiver. In some instances, time of day may comprise, for example, GPS time provided in an applicable GPS navigation message contained in satellite signals, just to illustrate one possible implementation. At times, a GPS navigation message may also include, for example, the difference or offset between GPS time and UTC. Thus, in some instances, a crowdsourcing mobile device may, for example, subtract this offset from GPS time to calculate UTC, such as in connection with suitable time zone values, if applicable.

As was indicated, an estimated location relative to time of day may, for example, be obtained contemporaneously with acquisition of one or more eLORAN positioning signals. In this context, “contemporaneously,” “contemporaneous,” or like terms refer to a concept of a mutual temporal reference with respect to two or more signals and/or phenomena obtained or acquired in substantially the same period of time. In some instances, a mutual temporal reference may comprise, for example, a signaling sequence in which an acquisition of two or more signals and/or phenomena may differ in the amount of time attributable to electronic communication or other signal processing. By way of example but not limitation, in at least one implementation, an estimated location of a mobile device may be considered to be obtained contemporaneously with one or more eLORAN positioning signals if such a location estimate is obtained within 5.0 seconds or less from the acquired positioning signal (or vice versa).

In some instances, positioning signal and location estimate acquisitions within a device amongst one or more devices in a given area for the purpose of determining ASF values and/or ASF value updates may be defined using a time threshold, for example, that may be pre-set or dynamically determined based, at least in part, on a mobile device's movement, accuracy of the last position fix, historical movement pattern of a mobile device, etc., or any combination thereof. For example, such a time threshold may be set to within 10.0 minutes of the last position fix if a mobile device has not moved, which may be determined based, at least in part, on various approaches, such as Cell IDs from nearby wireless transceivers, fingerprints of wireless signals, using inertial sensors on a mobile device, etc., or any combination thereof. If a mobile device has moved, however, then a time threshold may, for example, be set to 1.0 second, as another possible implementation, meaning that a position fix that was obtained within 1.0 second from acquisition of an applicable positioning signal may be considered to be “contemporaneous,” such as for purposes of crowdsourcing, for example. On the other hand, frequency of measurements and/or time thresholds may alternately be determined, at least in part, by factors that may indicate more likely ASF variations, such as based, at least in part, on one or more applicable historical records of weather and/or other factors that may change ground conductivity, for example.

At operation 206, one or more messages comprising the one or more ASF measurements and the estimated location relative to the time of day may, for example, be transmitted to a server. For example, in some instances, these one or more messages may be transmitted to a server for use in updating one or more ASF correction parameters. As was indicated, here, any suitable “push” or “pull” approach or combination of approaches may be utilized, in whole or in part. For messaging, one or more ASF measurements and an estimated location relative to time of day may, for example, be paired or combined in connection with any suitable communication protocol and/or process, such as via encoding, modulating, demodulating, decoding, etc. one or more properties of an appropriate wireless signal. These or like techniques are generally known and need not be described here in greater detail. In some instances, a message comprising crowdsourced data (e.g., a GNSS position fix relative to time of day, ASF measurements, TOA measurements, etc.) may, for example, be aggregated and/or stored in some manner, such as in a suitable local memory or a portion thereof (e.g., a buffer, local cache, etc.), such as prior to transmitting to a server and/or peer device. Optionally or alternatively, crowdsourced data may, for example, be transmitted to a server in real or near real time, such as at or upon acquisition of one or more eLORAN positioning signals, obtaining a GNSS position fix, ASF measurement, etc., or any combination thereof. As such, one or more messages with crowdsourced data may, for example, be transmitted on a relatively periodic or continual basis.

In an implementation, one or more messages with crowdsourced data may, for example, be transmitted using a cellular or like communication protocol and/or channel, such as utilizing, at least in part, a cellular receiver of a mobile device. At times, this may, for example, provide advantages over messages transmitted via the LDC, such as in terms of improved throughput or like transmission data rates since the LDC may typically suffer from relatively lower transmission data rates due, at least in part, to known limitations on modulating a LORAN pulse. As such, utilizing a cellular receiver, a mobile device may, for example, be capable of transmitting a message once per second, as one possible example, rather than once per minute, such as via conventional LDC communications. In turn, more frequent transmissions of crowdsourced data may facilitate and/or support more frequent updates of ASF values, as discussed below, which may, for example, help to at least partially eliminate or reduce ASF reporting errors from fixed transmitters and/or receivers, provide real-time or near real-time ASF distributions, or the like.

Thus, having received one or more messages, a server may, for example, process crowdsourced ASF measurements for particular locations (in relation to applicable time of day) of participating mobile devices. A server may, for example, combine crowdsourced ASF measurements (and associated location/time estimates) to compute one or more ASF correction parameters and may generate or update an ASF map for one or more geographic areas of interest. An ASF map may typically comprise a grid or distribution of ASF values at uniform or regular spacing (e.g., 500 meters grid spacing, etc.) mapped to a particular eLORAN transmitter. In some instances, grids may follow latitude and longitude lines of an Earth-centered, Earth-fixed terrestrial geodetic reference system, such as the World Geodetic System of 1984 (WGS84), just to illustrate one possible implementation. ASF maps are generally known and need not be described here in greater detail. Having updated ASF correction parameters, a server may subsequently distribute new ASF values and/or ASF corrections (e.g., as an ASF map, separate ASF correction values, etc.) to client mobile devices as part of positioning assistance data and/or an applicable eLORAN transmitter via a cellular communication channel or the LDC for use in subsequent eLORAN positioning operations. For example, a client mobile device, using an associated eLORAN receiver, may interpolate transmitted and/or stored grid values to arrive at its estimated position, as discussed above.

It should be noted that, in at least one implementation, instead of obtaining ASF measurements (along with applicable data) and transmitting the ASF measurements (along with applicable data) to a server, a crowdsourcing mobile device may, for example, transmit one or more messages comprising TOA measurements from observations of eLORAN positioning signals. New or updated ASF correction parameters may then be computed at a server based, at least in part, on these measurements, such as using one or more techniques discussed above.

In at least one implementation, one or more messages comprising crowdsourced data may, for example, be transmitted to a peer device rather than to a server. In this context, “peer device” refers to one or more mobile devices having one or more relatively equipotent or semi-equipotent functionalities and/or features that may facilitate and/or support one or more processes or operations discussed herein. For example, a crowdsourcing mobile device may transmit one or more messages with requisite parameters discussed above to a peer device for computing one or more ASF correction parameters and subsequent forwarding of these parameters to a server, another mobile device (e.g., a client mobile device, etc.), and/or an eLORAN transmitter and/or receiver. In another implementation, a crowdsourcing mobile device having a GNSS receiver but lacking an eLORAN receiver may transmit an estimated location obtained via a GNSS position fix to a proximate peer device with an eLORAN receiver for combining or correlating these measurements in a message and transmitting the message to a server for computing ASF corrections, as discussed above. At times, a plurality of crowdsourcing mobile devices may transmit one or more messages with crowdsourced data to a peer device acting as a “hub” via the LDC, for example, and the peer device may forward the messages to a server, eLORAN transmitter, etc. via a cellular communication channel, as another possible implementation. These or like peer communications may, for example, be implemented, at least in part, in connection with one or more applicable protocols, such as Wi-Fi Direct, LTE Direct, Bluetooth®, or the like. Of course, these are merely details relating to peer devices and/or peer communications, and claimed subject matter is not so limited.

FIG. 3 is a schematic flow diagram illustrating an implementation of an example use case or scenario 300 of improved eLORAN positioning via crowdsourcing for use in or with mobile devices, such as a mobile device 302 and/or other mobile device(s) 304, for example. As was indicated, mobile devices 302 and/or 304 may comprise, for example, one or more crowdsourcing mobile devices, client mobile devices, peer mobile devices, or any combination thereof. As seen, at times, mobile devices 302 and/or 304 may be capable of receiving, in whole or in part, wireless signals from a number of systems and/or devices, such as, for example, eLORAN 306, a cellular or like communication network 308, and/or a GNSS 310. Again, even though a certain number of particular devices, networks, navigation systems, servers, stations, links, etc. are illustrated, any number and/or type of suitable devices, networks, navigation systems, servers, stations, links, etc. may be implemented herein. Also, depending on an implementation, a single and/or double-sided arrow may, for example, indicate a unidirectional flow, a bi-directional flow, or any combination thereof, such as with respect to signals, operations, processes, communications, or the like. In some instances, an environment associated with mobile devices 302 and/or 304 may comprise, for example, an outdoor environment, indoor-like environment, or any combination thereof, and may include one or more features or aspects of operating environment 100 of FIG. 1.

Thus, using mobile device 302 as an illustrative example, as seen, it may comprise, for example, an eLORAN receiver 312 capable of communicating with eLORAN 306, a GNSS receiver 314 (having a database of relevant ASF values for an area) capable of communicating with GNSS 310, and a cellular receiver 316 capable of communicating with cellular or like network 308. Although not shown, mobile devices 302 and/or 304 may comprise other parts and/or components (e.g., a processor, memory, etc.) that may, for example, be used, at least in part, to facilitate and/or support one or more operations or techniques discussed herein. Again, an example of a mobile device that may be used, at least in part, to facilitate and/or support one or more operations and/or techniques for improved eLORAN positioning via crowdsourcing will be discussed in greater detail below with reference to FIG. 4.

As discussed above, using eLORAN receiver 312, mobile device 302 may, for example, receive a LORAN pulse from one or more applicable eLORAN transmitters and may obtain a contemporaneous GNSS position fix in relation to GPS time, such as using GNSS receiver 314. As illustrated via an arrow at 318, GNSS receiver 314 may, for example, provide a GNSS position fix and GPS time to eLORAN receiver 312 so as to obtain a TOA of an applicable LORAN pulse, as was also indicated. eLORAN receiver 312 may, for example, communicate with a timing measurement unit (TMU) 320, such as to confirm and/or convert GPS time to UTC, if suitable or needed. As seen, in some instances, time of day may also be provided to TMU 320 by cellular receiver 316, such as an optional or alternative time reference for TOA determination, for example. Based, at least in part, on an obtained TOA, one or more corresponding ASF measurements may, for example, be determined, as illustrated at 322, such as using one or more techniques discussed herein. As also illustrated, in some instances, ASF determination may also account for timing reference provided by cellular receiver 316, for example. It should be noted that, in some instances, mobile device 302 may, for example, receive a LORAN pulse from one or more applicable eLORAN transmitters and may obtain a contemporaneous GNSS position fix in relation to UTC, such as using GNSS receiver 314, in which case conversion from GPS time may not be needed or otherwise useful.

As illustrated at 324, in an implementation, a final position may, for example be determined by utilizing or otherwise considering a GNSS-derived position fix, such as provided by GNSS receiver 314, for example, and an eLORAN-derived position fix, such as provided by eLORAN receiver 312, if applicable or useful. Thus, at times, a number of position fixes may, for example, be compared and/or combined in some manner (e.g., using weights, approximation algorithms, processing filters, etc.) so as to arrive at a final position, which may be provided to cellular receiver 316. As also seen, in turn, cellular receiver 316 may, for example, transmit a final position along with other applicable crowdsourced data discussed above to a server and/or peer device, referenced generally at 326, and/or other mobile device(s) 304, such as using a cellular communication channel and/or protocol, as was also indicated. Server and/or peer device 326 may, for example, process crowdsourced data so as to update ASF correction parameters using one or more approached discussed above. Server and/or peer device 326 may then transmit ASF values/corrections (e.g., as an ASF map, etc.) to one or more appropriate eLORAN receivers and/or transmitters, client mobile devices, etc., or any combination thereof, for use in subsequent eLORAN positioning operations. Of course, a description of certain aspects of use case or scenario 300 is merely an example, and claimed subject matter is not so limited. For example, at times, a suitable server and/or peer device may accumulate and/or store one or more ASF estimates and/or derived ASF values in a suitable database or like repository (e.g., a buffer, etc.), such as for historical record keeping, facilitating and/or supporting future ASF determinations based, at least in part, on historical data, or the like.

Accordingly, as discussed herein, one or more operations and/or techniques for improved eLORAN positioning via crowdsourcing for use in or with mobile devices may provide benefits. For example, obtaining and/or reporting current ASF measurements (along with other applicable data) on a continual basis may help improve existing LORAN pulse propagation models that may suffer from lack of more reliable and/or dynamic ground-conductivity data. In addition, geographically dispersed and/or more finely granular geographic coverage by crowdsourcing mobile devices may result in broader ASF coverage and/or ASF diversity, for example, which may be superior to a number of existing fixed LORAN reference stations (e.g., differential eLORAN, LORAN-C, etc.). Also, improved eLORAN positioning via crowdsourcing may assists or, in some instances, replace GNSS position determination in compromised scenarios, as was indicated. Crowdsourcing may also be capable of leveraging ecosystem, for example, and/or taking advantages of a ubiquitous smart phone market and/or devices.

Another benefit of improved eLORAN positioning via crowdsourcing, such as using a cellular or other transmission medium may be an implementation of a higher or otherwise sufficient data throughput or transmission rate, for example, such as while maintaining the integrity of various deployed LORAN-type systems. For example, as discussed above, increasing data throughput rate of the LDC may be relatively difficult using existing LORAN-type equipment and/or systems. At times, modifications to legacy signal generation equipment may, for example, be more expensive than simply replacing the equipment with more modern versions. As such, utilizing crowdsourcing mobile devices (rather than fixed infrastructure with timed and/or granular reports) having relatively frequent communications with a server (or peer device), for example, may eliminate or reduce a statistically significant number of seasonal and/or temporal variations in ASF. This may also facilitate and/or support timely generation and/or updates of relevant ASF values, for example, so as to arrive at real-time or near-real time ASF maps. A more dynamic system capable of communicating and/or varying transmissions of ASF correction parameters at different (e.g., higher, etc.) throughput rates may also have a superior bad-weather capability due, at least in part, to the ability of implementing more frequent ASF reports.

Further, messages comprising crowdsourcing or other data (e.g., ASF corrections, etc.) may, for example, be standardized as part of a positioning procedure in some manner. For example, depending on an implementation, one or more servers discussed herein (e.g., servers 116, 118, and/or 120 of FIG. 1, server 326 of FIG. 3, etc.) may comprise a central server comprising (i) an Enhanced Serving Mobile Location Center (E-SMLC) as described in 3GPP Technical Specifications (TSs) 23.271 and 36.305; (ii) a Secure User Plane Location (SUPL) Location Platform (SLP) as defined by the Open Mobile Alliance (OMA) for the SUPL location solution; or (iii) a Home SLP (H-SLP), Discovered SLP (D-SLP) or Emergency SLP (E-SLP) as further defined by OMA, or any combination thereof. As such, one or more crowdsourcing or other messages may comprise messages transmitted according to the LTE Positioning Protocol (LPP) defined in 3GPP TS 36.355, messages transmitted according to the LPP Extensions Protocol (LPPe) defined by OMA or messages transmitted according to the SUPL User plane Location Protocol (ULP) defined by OMA. In some instances, these or like messages may comprise (i) a ULP message in which one or more LPP messages are embedded; (ii) a ULP message in which one or more LPP messages are embedded, wherein one or more of the embedded LPP messages each contain an embedded LPPe message; or (iii) an LPP message in which one LPPe message is embedded. Accordingly, one or more standardization aspects discussed above may facilitate and/or support improved position determination, such as more timely and/or accurate position determination, for example. Of course, such a description of certain aspects of improved eLORAN positioning via crowdsourcing and its benefits is merely an example, and claimed subject matter is not so limited.

FIG. 4 is a schematic diagram of an implementation of an example computing environment associated with a mobile device that may be used, at least in part, to facilitate or support one or more operations and/or processes for improved eLORAN positioning via crowdsourcing. An example computing environment may comprise, for example, a mobile device 400 that may include one or more features or aspects of mobile device 102 of FIG. 1 and/or mobile device 302 of FIG. 3, though claimed subject matter is not so limited. For example, in some instances, mobile device 400 may comprise a wireless transceiver 402 capable of transmitting and/or receiving wireless signals, referenced generally at 404, such as via an antenna 406 over a suitable wireless communications network. In some instances, wireless transceiver 402 may comprise, for example, a cellular receiver and/or transmitter capable of sending and/or receiving one or more suitable communications via a cellular channel and/or protocol, such as one or more communications discussed with reference to FIGS. 1-3. Wireless transceiver 402 may, for example, be coupled or connected to a bus 408 via a wireless transceiver bus interface 410. Depending on an implementation, at times, wireless transceiver bus interface 410 may, for example, be at least partially integrated with wireless transceiver 402. Some implementations may include multiple wireless transceivers 402 or antennas 406 so as to enable transmitting and/or receiving signals according to a corresponding multiple wireless communication standards, such as Wireless Local Area Network (WLAN) or Wi-Fi, Code Division Multiple Access (CDMA), Wideband-CDMA (W-CDMA), Long Term Evolution (LTE), Bluetooth®, just to name a few examples.

In an implementation, mobile device 400 may, for example, comprise an SPS or like receiver 412 capable of receiving or acquiring one or more SPS or other suitable wireless signals 414, such as via an SPS or like antenna 416. SPS receiver 412 may process, in whole or in part, one or more acquired SPS signals 414 for determining a location of mobile device 400, such as in relation to time of day, for example. In some instances, one or more general-purpose application processors 418 (henceforth referred to as “processor”), memory 420, digital signal processor(s) (DSP) 422, or like specialized devices or processors not shown may be utilized to process acquired SPS signals 414, in whole or in part, calculate a location of mobile device 400, such as in conjunction with SPS receiver 412, or the like. Storage of SPS or other signals for implementing one or more positioning operations, such as in connection with one or more techniques for improved eLORAN positioning via crowdsourcing for use in or with mobile devices, for example, may be performed, at least in part, in memory 420, suitable registers or buffers (not shown). Although not shown, it should be appreciated that in at least one implementation one or more processors 418, memory 420, DSPs 422, or like specialized devices or processors may comprise one or more processing modules capable of acquiring one or more Enhanced Long-Range Navigation (eLORAN) positioning signals to obtain one or more Additional Secondary Factor (ASF) measurements; obtaining, via a Global Navigation Satellite System (GNSS), an estimated location of mobile device 400 relative to time of day; and transmitting one or more messages comprising the one or more ASF measurements and the estimated location relative to the time of day to a server.

It should be noted that all or part of one or more processing modules may be implemented using or otherwise including hardware, firmware, software, or any combination thereof. Processing modules may be representative of one or more circuits capable of performing at least a portion of information computing technique or process. By way of example but not limitation, processor 418 or DSP 422 may include one or more processors, controllers, microprocessors, microcontrollers, application specific integrated circuits, digital signal processors, programmable logic devices, field programmable gate arrays, or the like, or any combination thereof. Thus, at times, processor 418 or DSP 422 or any combination thereof may comprise or be representative of means for acquiring one or more Enhanced Long-Range Navigation (eLORAN) positioning signals to obtain one or more Additional Secondary Factor (ASF) measurements, such as to implement operation 202 of FIG. 2, at least in part. In addition, in at least one implementation, processor 418 or DSP 422 may be representative of or comprise, for example, means for obtaining, via a Global Navigation Satellite System (GNSS), an estimated location of mobile device 400 relative to time of day, such as to implement operation 204 of FIG. 2, at least in part. Also, in some instances, processor 418 or DSP 422 or any combination thereof may comprise or be representative of means for transmitting one or more messages comprising the one or more ASF measurements and the estimated location relative to the time of day to a server, such as to implement operation 206 of FIG. 2, at least in part.

As illustrated, DSP 422 may be coupled or connected to processor 418 and memory 420 via bus 408. Although not shown, in some instances, bus 408 may comprise one or more bus interfaces that may be integrated with one or more applicable components of mobile device 400, such as DSP 422, processor 418, memory 420, or the like. In various embodiments, one or more operations or functions described herein may be performed in response to execution of one or more machine-readable instructions stored in memory 420, such as on a computer-readable storage medium, such as RAM, ROM, FLASH, disc drive, etc., just to name a few examples. Instructions may, for example, be executable via processor 418, one or more specialized processors not shown, DSP 422, or the like. Memory 420 may comprise a non-transitory processor-readable memory, computer-readable memory, etc. that may store software code (e.g., programming code, instructions, etc.) that may be executable by processor 418, DSP 422, or the like to perform operations or functions described herein.

Mobile device 400 may comprise a user interface 424, which may include any one of several devices such as, for example, a speaker, microphone, display device, haptic feedback device, keyboard, touch screen, etc., just to name a few examples. In at least one implementation, user interface 424 may enable a user to interact with one or more applications hosted on mobile device 400. For example, one or more devices of user interface 424 may store analog or digital signals on memory 420 to be further processed by DSP 422, processor 418, etc. in response to input or action from a user. Similarly, one or more applications hosted on mobile device 400 may store analog or digital signals in memory 420 to present an output signal to a user. In some implementations, mobile device 400 may optionally include a dedicated audio input/output (I/O) device 426 comprising, for example, a dedicated speaker, microphone, digital to analog circuitry, analog to digital circuitry, amplifiers, gain control, or the like. It should be understood, however, that this is merely an example of how audio I/O device 426 may be implemented, and that claimed subject matter is not limited in this respect. As seen, mobile device 400 may comprise one or more touch sensors 428 responsive to touching or like pressure applied on a keyboard, touch screen, or the like.

In an implementation, mobile device 400 may comprise, for example, an eLORAN receiver 430 capable of receiving or acquiring one or more eLORAN positioning signals or other suitable positioning data (e.g., location, identity of an eLORAN transmitter, etc.), as discussed above, such as via an eLORAN receiver antenna 431. eLORAN receiver 430 may, for example, be coupled or connected to a bus 408 via a wireless transceiver bus interface (not shown). Depending on an implementation, at times, the wireless transceiver bus interface may, for example, be at least partially integrated with eLORAN receiver 430. Some implementations may include multiple eLORAN receiver 430 or antennas 431 so as to enable transmitting and/or receiving wireless signals according to a various applicable communication standards and/or protocols. As was also discussed, eLORAN receiver 430 may process, in whole or in part, one or more acquired eLORAN positioning signals to obtain one or more ASF measurements, eLORAN-derived position fix, or the like. In some instances, eLORAN receiver may also be capable of communication suitable data via the LDC, for example. At times, one or more suitable processing operations, such as obtaining TOA measurements, computing ASF values, converting GPS time to UTC, etc. may, for example be performed via an ASF/TOA processor 432. Optionally or alternatively, ASF/TOA processor 432 may perform conditioning, encoding, compression, and/or manipulation of eLORAN positioning signals to facilitate and/or support one or more operations or techniques discussed herein. For example, ASF/TOA processor 432 may decode one or more stored ASF values for presentation via an ASF map.

Mobile device 400 may comprise one or more sensors 434 coupled or connected to bus 408, such as, for example, one or more inertial sensors, ambient environment sensors, or the like. Inertial sensors of sensors 434 may comprise, for example, one or more accelerometers (e.g., collectively responding to acceleration of mobile device 400 in one, two, or three dimensions, etc.), gyroscopes or magnetometers (e.g., to support one or more compass or like applications, etc.), etc., just to illustrate a few examples. Ambient environment sensors of mobile device 400 may comprise, for example, one or more barometric pressure sensors, temperature sensors, ambient light detectors, camera sensors, microphones, etc., just to name few examples. Sensors 434 may generate analog or digital signals that may be stored in memory 420 and may be processed by DSP 422, processor 418, etc., such as in support of one or more applications directed to positioning or navigation operations, wireless communications, radio heat map learning, video gaming or the like.

In a particular implementation, mobile device 400 may comprise, for example, a modem processor 436, dedicated or otherwise, capable of performing baseband processing of signals received or downconverted via wireless transceiver 402, SPS receiver 412, or the like. Similarly, modem processor 436 may perform baseband processing of signals to be upconverted for transmission via wireless transceiver 402, for example. In alternative implementations, instead of having a dedicated modem processor, baseband processing may be performed, at least in part, by processor 418, DSP 422, or the like. In addition, in some instances, an interface 438, although illustrated as a separate component, may be integrated, in whole or in part, with one or more applicable components of mobile device 400, such as bus 408 or SPS receiver 412, for example. Optionally or alternatively, SPS receiver 412 may be coupled or connected to bus 408 directly. It should be understood, however, that these are merely examples of components or structures that may perform baseband processing, and that claimed subject matter is not limited in this regard.

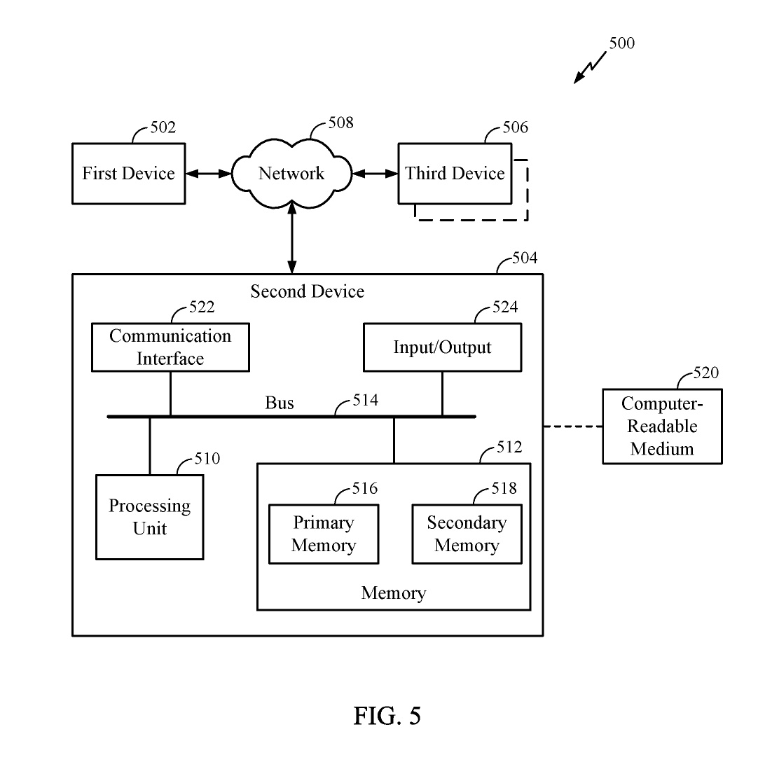

FIG. 5 is a schematic diagram illustrating an implementation of an example computing environment or system 500 that may be associated with or include one or more servers or other devices (e.g., peer devices, etc.) capable of partially or substantially implementing or supporting one or more operations and/or processes for improved eLORAN positioning via crowdsourcing for use in or with mobile devices, such as discussed above in connection with FIGS. 1-3, for example. Computing environment 500 may include, for example, a first device 502, a second device 504, a third device 506, etc., which may be operatively coupled together via a communications network 508. In some instances, first device 502 may comprise a server capable of providing positioning assistance parameters, such as, for example, identities, locations, etc. of known wireless transmitters (e.g., eLORAN transmitters, etc.), radio heat map, base station almanac, electronic digital map, database of wireless transmitters, database of ASF values, ASF values/corrections, ASF maps, bias estimates, signal measurements, or the like. For example, first device 502 may also comprise a server capable of providing an electronic digital map to a mobile device based, at least in part, on a coarse or rough estimate of a location of the mobile device, upon request, or the like. First device 502 may also comprise a server capable of providing any other suitable positioning assistance parameters (e.g., an ASF map, radio heat map, etc.), relevant to a location of a mobile device. Second device 504 or third device 506 may comprise, for example, peer mobile devices, as discussed above, though claimed subject matter is not so limited. For example, in some instances, second device 504 may comprise a server functionally or structurally similar to first device 502, just to illustrate another possible implementation. In addition, communications network 508 may comprise, for example, one or more wireless transmitters, such as access points, femtocells, or the like, eLORAN transmitters and/or receivers, client mobile devices, wired and/or wireless communication links, etc. Of course, claimed subject matter is not limited in scope in these respects.

First device 502, second device 504, or third device 506 may be representative of any device, appliance, platform, or machine that may be capable of exchanging parameters and/or information over communications network 508. By way of example but not limitation, any of first device 502, second device 504, or third device 506 may include: one or more computing devices or platforms, such as, for example, a desktop computer, a laptop computer, a workstation, a server device, a peer device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 502, 504, and 506, respectively, may comprise one or more of a mobile device, wireless transmitter and/or receiver, server, peer device, etc. in accordance with example implementations described herein.

In an implementation, communications network 508 may be representative of one or more communication links, processes, or resources capable of supporting an exchange of information between at least two of first device 502, second device 504, or third device 506. By way of example but not limitation, communications network 508 may include wireless and/or wired communication links, telephone and/or telecommunications systems, information buses and/or channels, optical fibers, terrestrial and/or space vehicle resources, local area networks, wide area networks, intranets, the Internet, routers and/or switches, or the like, or any combination thereof. As illustrated, for example, via a dashed lined box partially obscured by third device 506, there may be additional like devices operatively coupled to communications network 508. It is also recognized that all or part of various devices or networks shown in computing environment 500, or processes or methods, as described herein, may be implemented using or otherwise including hardware, firmware, software, or any combination thereof.

By way of example but not limitation, second device 504 may include at least one processing unit 510 that may be operatively coupled to a memory 512 via a bus 514. Processing unit 510 may be representative of one or more circuits capable of performing at least a portion of a suitable computing procedure or process. For example, processing unit 510 may include one or more processors, controllers, microprocessors, microcontrollers, application specific integrated circuits, digital signal processors, programmable logic devices, field programmable gate arrays, or the like, or any combination thereof. Although not shown, second device 504 may include a location-tracking unit that may initiate a position fix of a suitable mobile device, such as in an area of interest, for example, based, at least in part, on one or more received or acquired wireless signals, such as from an SPS, one or more Wi-Fi access points, eLORAN transmitters, etc. In some implementations, a location-tracking unit may be at least partially integrated with a suitable processing unit, such as processing unit 510, for example, though claimed subject matter is not so limited. In certain server-based or server-supported implementations, processing unit 510 may, for example, at least partially comprise means for receiving first messages from a plurality of reporting mobile devices comprising one or more ASF measurements based, at least in part, on eLORAN positioning signals acquired at the reporting mobile devices, and estimates of locations of the reporting mobile devices relative to time of day contemporaneous with the acquisitions of the eLORAN positioning signals, such as to facilitate and/or support operations 202, 204, and/or 206 of FIG. 2, at least in part. In some instances, processing unit 510 may, for example, at least partially comprise means for computing one or more updated ASF parameters based, at least in part, on the estimates of locations of the reporting mobile devices relative to the time of day and the one or more ASF measurements, such as to facilitate and/or support operations 202, 204, and/or 206 of FIG. 2, at least in part. At times, processing unit 510 may, for example, at least partially comprise means for transmitting one or more second messages comprising one or more updated ASF parameters to one or more client mobile devices or eLORAN receiving stations or eLORAN transmitting stations, such as to facilitate and/or support operations 202, 204, and/or 206 of FIG. 2, at least in part.

Memory 512 may be representative of any information storage mechanism or appliance. Memory 512 may include, for example, a primary memory 516 and a secondary memory 518. Primary memory 516 may include, for example, a random access memory, read only memory, etc. While illustrated in this example as being separate from processing unit 510, it should be understood that all or part of primary memory 516 may be provided within or otherwise co-located/coupled with processing unit 510. Secondary memory 518 may include, for example, same or similar type of memory as primary memory or one or more information storage devices or systems, such as, for example, a disk drive, an optical disc drive, a tape drive, a solid state memory drive, etc. In certain implementations, secondary memory 518 may be operatively receptive of, or otherwise configurable to couple to, a computer-readable medium 520. Computer-readable medium 520 may include, for example, any non-transitory storage medium that may carry or make accessible information, code, or instructions for one or more of devices in computing environment 500. Computer-readable medium 520 may also be referred to as a machine-readable medium, storage medium, or the like.

Second device 504 may include, for example, a communication interface 522 that may provide for or otherwise support an operative coupling of second device 504 to at least communications network 508. By way of example but not limitation, communication interface 522 may include a network interface device or card, a modem, a router, a switch, a transceiver, and the like. Second device 504 may also include, for example, an input/output device 524. Input/output device 524 may be representative of one or more devices or features that may be configurable to accept or otherwise introduce human or machine inputs, or one or more devices or features that may be capable of delivering or otherwise providing for human or machine outputs. By way of example but not limitation, input/output device 524 may include an operatively configured display, speaker, keyboard, mouse, trackball, touch screen, information port, or the like.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units de-signed to perform the functions described herein, or combinations thereof.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, messages, parameters, frames, packets, content and/or the like. It should be understood, however, that all of these and/or similar terms are to be associated with appropriate physical quantities or manifestations, and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. Likewise, operation of a memory device to store bits, values, elements, symbols, characters, terms, numbers, numerals, measurements, messages, parameters, frames, packets, content and/or the like may comprise a physical transformation. With particular types of memory devices, such a physical transformation may comprise a physical transformation of an article to a different state or thing. For example, but without limitation, for some types of memory devices, a change in state may involve an accumulation and/or storage of charge or a re-lease of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) net-work, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, in which “x” may represent any suitable known protocol and/or protocol that may be developed in the future and may include, for example, “a” (802.11a), “b” (802.11b), “g” (802.11g), “h” (802.11h), or like protocols, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that transmits a PN code or other ranging code (e.g., similar to a GPS or CDMA cellular signal). In some instances, terrestrial transmitters may comprise, for example, eLORAN transmitters that transmit LORAN pulses, as discussed above. Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban or natural canyons, foliage, or other partially or substantially enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method comprising:
acquiring one or more Enhanced Long-Range Navigation (eLORAN) positioning signals to obtain one or more Additional Secondary Factor (ASF) measurements;
obtaining, via a Global Navigation Satellite System (GNSS), an estimated location of a mobile device relative to time of day; and
transmitting one or more messages comprising the one or more ASF measurements and the estimated location relative to the time of day to a server.

2. The method of claim 1, and further comprising computing the one or more ASF measurements based, at least in part, on a time of flight (TOF) measurement computed based, at least in part, on a time of arrival (TOA) of the acquired one or more eLORAN positioning signals.

3. The method of claim 2, wherein the TOF measurement comprises a primary factor (PF) and a secondary factor (SF)-corrected TOF measurement.

4. The method of claim 1, and further comprising obtaining the estimated location of the mobile device via an eLORAN navigation system.

5. The method of claim 4, and further comprising determining a final estimated location of the mobile device based, at least in part, on a comparison of the estimated location obtained via the GNSS with the estimated location obtained via the eLORAN navigation system.

6. The method of claim 1, wherein the estimated location of the mobile device is based, at least in part, on a GPS-derived position fix.

7. The method of claim 1, wherein the time of day comprises Coordinated Universal Time (UTC) or GPS time.

8. The method of claim 1, wherein the one or more ASF measurements and the estimated location relative to the time of day are used, at least in part, for generating or updating an ASF map.

9. The method of claim 8, wherein the ASF map comprises a real-time or near real-time ASF map.

10. The method of claim 1, wherein the one or more messages are transmitted to the server via a cellular communication channel or a LORAN data channel (LDC).

11. The method of claim 1, wherein the estimated location of the mobile device relative to the time of day is obtained contemporaneously with the acquisition of the one or more eLORAN positioning signals.

12. The method of claim 1, wherein the one or more messages are transmitted according to at least one of the following: an LTE positioning protocol (LPP); an LPP extensions (LPPe) protocol; a Secure User Plane Location (SUPL) user plane location protocol (ULP); or any combination thereof.

13. An apparatus comprising:
a communication interface to communicate with an electronic communications network, the communication interface configured to:
acquire one or more eLORAN positioning signals to obtain one or more ASF measurements; and
obtain, via a GNSS, an estimated location of a mobile device relative to time of day; and
one or more processors coupled to a memory and to the communication interface, the one or more processors configured to:
transmit one or more messages comprising the one or more ASF measurements and the estimated location relative to the time of day to a server.

14. The apparatus of claim 13, wherein the one or more ASF correction parameters are used, at least in part, for generating or updating a real-time or near real-time ASF map.

15. The apparatus of claim 13, wherein the one or more messages are transmitted to the server via a cellular communication channel or a LORAN data channel (LDC).

16. The apparatus of claim 13, wherein the one or more messages are transmitted according to at least one of the following: an LTE positioning protocol (LPP); an LPP extensions (LPPe) protocol; a Secure User Plane Location (SUPL) user plane location protocol (ULP); or any combination thereof.

17. A method, at a server, comprising:
receiving first messages from a plurality of reporting mobile devices comprising one or more ASF measurements based, at least in part, on eLORAN positioning signals acquired at the reporting mobile devices, and estimates of locations of the reporting mobile devices relative to time of day contemporaneous with the acquisitions of the eLORAN positioning signals;
computing one or more updated ASF parameters based, at least in part, on the estimates of locations of the reporting mobile devices relative to the time of day and the one or more ASF measurements; and
transmitting one or more second messages comprising one or more updated ASF parameters to one or more client mobile devices or eLORAN receiving stations or eLORAN transmitting stations.

18. The method of claim 17, wherein the one or more ASF measurements are computed based, at least in part, on a TOF measurement computed based, at least in part, on TOA of the acquired one or more eLORAN positioning signals.

19. The method of claim 18, wherein the TOF measurement comprises a PF and an SF-corrected TOF measurement.

20. The method of claim 17, wherein the reporting mobile devices comprise at least one of the following: crowdsourcing mobile devices; peer devices; or any combination thereof.

21. The method of claim 17, wherein the time of day comprises Coordinated Universal Time (UTC) or GPS time.

22. The method of claim 17, wherein the estimates of locations of the reporting mobile devices are obtained via at least one of the following: a GNSS; eLORAN; or any combination thereof.

23. The method of claim 17, wherein the updated ASF parameters comprise an ASF map.

24. The method of claim 23, wherein the ASF map comprises a real-time or near real-time ASF map.

25. The method of claim 17, wherein the first messages are received via a cellular communication channel or a LORAN data channel (LDC).

26. The method of claim 17, wherein the second messages are transmitted according to at least one of the following: an LTE positioning protocol (LPP); an LPP extensions (LPPe) protocol; a Secure User Plane Location (SUPL) user plane location protocol (ULP); or any combination thereof.

27. An apparatus comprising:
a communication interface to transmit messages to and receive messages from a plurality of communication devices, the communication interface configured to:
receive first messages from a plurality of reporting mobile devices comprising one or more ASF measurements based, at least in part, on eLORAN positioning signals acquired at the reporting mobile devices, and estimates of locations of the reporting mobile devices relative to time of day contemporaneous with the acquisitions of the eLORAN positioning signals; and
one or more processors coupled to a memory and to the communication interface, the one or more processors configured to:
compute one or more updated ASF parameters based, at least in part, on the estimates of locations of the reporting mobile devices relative to the time of day and the one or more ASF measurements;
the communication interface further configured to:
transmit one or more second messages comprising one or more updated ASF parameters to one or more client mobile devices or eLORAN receiving stations or eLORAN transmitting stations.

28. The apparatus of claim 27, wherein the one or more ASF correction parameters are used, at least in part, for generating or updating a real-time or near real-time ASF map.

29. The apparatus of claim 27, wherein the one or more messages are transmitted to the server via a cellular communication channel or a LORAN data channel (LDC).

30. The apparatus of claim 27, wherein the one or more messages are transmitted according to at least one of the following: an LTE positioning protocol (LPP); an LPP extensions (LPPe) protocol; a Secure User Plane Location (SUPL) user plane location protocol (ULP); or any combination thereof.
